(19) United States
(12) Patent Application Publication
(10) Pub. No.: US 2008/0192265 A1
(43) Pub. Date: Aug. 14, 2008

(54) Systems and Methods for Communication Authentication

(76) Inventor: Daniel N. Weiss, Boca Raton, FL (US)

Correspondence Address: NEEDLE & ROSENBERG, P.C., SUITE 1000, 999 PEACHTREE STREET, ATLANTA, GA, 30309-3915, US

(21) Appl. No.: 11/660,151

(22) PCT Filed: Aug. 9, 2005
(86) PCT No.: PCT/US05/28109

§ 371 Date: Jun. 5, 2007

Related U.S. Application Data
(60) Provisional application No. 60/600,434, filed on Aug. 10, 2004.

(51) Int. Cl. H04N 1/32

(52) U.S. Cl. 358/1.6

(57) ABSTRACT

A device that can confirm the identity of a message recipient (303) and additionally can confirm the identity of a message sender (305) is issued to insure a message is received by the intended entity (306). Upon identification of an unapproved sender or recipient, the device will terminate communication, thereby preventing transmission of potentially sensitive information to an unintended party.

### RELATED APPLICATION

This application is claims priority to U.S. Provisional Patent Application No. 60/600,434, filed on Aug. 10, 2004, herein incorporated by reference in its entirety.

### BACKGROUND

Health care providers are required to keep personal medical information confidential. Currently, a majority of medical information is transmitted via facsimile (fax). Health care providers do not have a system for the transmission of medical information via fax in a confidential manner. Although encryption is readily available for transmission of medical information via the internet, transmission by fax, which is more common, is still fraught with peril in that until now there has been no way to authenticate who is receiving the information. Disclosed are methods and machines which address the issue of authenticated information transmission to authorized users to aid health care providers in keeping confidential patient information confidential.

### SUMMARY

Disclosed are methods and systems related to ensuring fax information is received by the intended entity. There currently exists no known method or system for the authenticated transmission of fax information. The methods and systems disclosed herein overcome this insecure method of transmission through the use of a device that can confirm the identity of a message recipient and additionally can confirm the identity of a message sender. The method implemented by the device is such that upon identification of an unapproved sender or recipient the device will terminate communication, thereby preventing transmission of potentially sensitive information to an unintended party. This method and system will allow fax transmission to be a communication method of choice in industries that transmit sensitive information.

### BRIEF DESCRIPTION OF THE DRAWINGS

The accompanying drawings, which are incorporated in and constitute a part of this specification, illustrate several embodiments and together with the description illustrate the disclosed compositions and methods.

FIG. 1. An overview of the basic process steps of the disclosed methods.

FIG. 2. A five substep flow chart for authentication of communication, which corresponds to steps 101 and 102 of FIG. 1.

FIG. 3. A six substep flow chart for authentication of communication, which corresponds to steps 101 and 102 of FIG. 1.

FIG. 4. A seven substep flow chart for authentication of communication, which corresponds to steps 101 and 102 of FIG. 1.

FIG. 5. A nine substep flow chart for authentication of communication, which corresponds to steps 101 and 102 of FIG. 1.

FIG. 6. A communication scenario wherein both communicating parties are using the disclosed methods and machines.

FIG. 7. An example of equipment setup in an embodiment during Apparatus to Apparatus communication.

FIG. 8. An example of equipment setup in an embodiment during Apparatus to non-Apparatus communication.

FIG. 9. An example of equipment setup in an embodiment during non-Apparatus to Apparatus communication.

FIG. 10. A block diagram illustrating an exemplary apparatus.

### DETAILED DESCRIPTION

Before the present systems and methods are disclosed and described, it is to be understood that the terminology used herein is for the purpose of describing particular embodiments only and is not intended to be limiting.

### DEFINITIONS

As used in the specification and the appended claims, the singular forms “a,” “an” and “the” include plural referents unless the context clearly dictates otherwise. Thus, for example, reference to “a device” includes mixtures of two or more such devices, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

“Sender” a party that causes a message to be directed or transmitted to a receiver.

“Receiver” a party intended by the sender to come into possession of a message. The word “recipient” is used interchangeably with “receiver.”

“Authentication” is confirming the identity of a Sender or a Receiver.

“Approved Caller List” (ACL) a collection of approved recipient phone numbers, also referred to as “communication addresses.” An ACL can be stored in a lightweight database or written into physical file structures such as arrays. The list can include associated unique identifier codes.

“Messages” are communications in writing, in speech, or by signals. Messages can include fax transmissions, telephone transmissions, images, email transmissions, or any other electronic data transmission.

“Unique Identifier Codes” (UIDC) are anything that allows a sender to be distinguished from all other senders and allows a receiver to be distinguished from all other receivers. A Unique Identifier can be a numeric string of any length, this includes phone numbers. A Unique Identifier can be an alphanumeric string of any length, an alphabetic string of any length, an image, or any other unique form of electronic data.

“Handshake Message Unit” (HMU), the interaction between apparatuses can be based on this message unit. The HMU can comprise a message header, a message body and a message trailer. Information such as the request type, conversation state etc., can be encoded into the message header, while the data to be transmitted between the apparatuses can be placed in the message body. The message trailer can be used for other purposes such as carrying DES or RSA keys for encryption purposes.

“EPROM”, Erasable Programmable Read-Only Memory, a type of non-volatile memory chip that can be programmed electrically and erased by exposing the chip to ultraviolet light.

“Admin Console”, a control device through which a user communicates with an apparatus via a primary input device (such as a keyboard or mouse) and a primary output device (such as a screen). A console integrates all the tools and information a user needs to perform specific tasks such as updating and maintaining an apparatus. An admin console can be integrated into an apparatus, integrated into a message communications device 1010 (such as a fax machine or a telephone), or it can be a personal computer with software designed to interface with the apparatus.

“Medical information” refers to any information as controlled by HIPPA.

“Provider” refers to anyone requiring authenticated message transmission, but can be health care professionals who perform financial or administrative transactions electronically. Examples of such providers are medical doctors, hospital staff, or insurance companies. It is to be understood that these and other providers can also be receivers of a message as described herein.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

Medical Confidentiality

The Health Insurance Portability and Protection Act of 1996 [HIPPA] requires medical professionals to protect patients' privacy by requiring safeguards to be put in place by medical professionals to ensure confidentiality. Most professionals were required to comply with HIPPA by Apr. 14, 2003. The regulations promulgated by the Department of Health and Human services ensure a national floor of privacy protections for patients by limiting the ways that health plans, pharmacies, hospitals and other covered entities can use patients' personal medical information. The regulations protect medical records and other individually identifiable health information, whether it is on paper, in computers or communicated orally. Patients generally should be able to see and obtain copies of their medical records and request corrections if they identify errors and mistakes. Health plans, doctors, hospitals, clinics, nursing homes and other covered entities generally should provide access these records within 30 days and may charge patients for the cost of copying and sending the records.

### 1. Notice of Privacy Practices

Covered health plans, doctors and other health care providers must provide a notice to their patients how they may use personal medical information and their rights under the new privacy regulation. Doctors, hospitals and other direct-care providers generally will provide the notice on the patient's first visit following the Apr. 14, 2003, compliance date and upon request. Patients generally will be asked to sign, initial or otherwise acknowledge that they received this notice. Health plans generally must mail the notice to their enrollees by April 14 and again if the notice changes significantly. Patients also may ask covered entities to restrict the use or disclosure of their information beyond the practices included in the notice, but the covered entities would not have to agree to the changes.

### 2. Limits on Use of Personal Medical Information

The privacy rule sets limits on how health plans and covered providers may use individually identifiable health information. To promote the best quality care for patients, the rule does not restrict the ability of doctors, nurses and other providers to share information needed to treat their patients. In other situations, though, personal health information generally may not be used for purposes not related to health care, and covered entities may use or share only the minimum amount of protected information needed for a particular purpose. In addition, patients would have to sign a specific authorization before a covered entity could release their medical information to a life insurer, a bank, a marketing firm or another outside business for purposes not related to their health care.

The final privacy rule sets new restrictions and limits on the use of patient information for marketing purposes. Pharmacies, health plans and other covered entities must first obtain an individual's specific authorization before disclosing their patient information for marketing. At the same time, the rule permits doctors and other covered entities to communicate freely with patients about treatment options and other health-related information, including disease-management programs.

### 3. Stronger State Laws

The new federal privacy standards do not affect state laws that provide additional privacy protections for patients. The confidentiality protections are cumulative; the privacy rule will set a national “floor” of privacy standards that protect all Americans, and any state law providing additional protections would continue to apply. When a state law requires a certain disclosure—such as reporting an infectious disease outbreak to the public health authorities—the federal privacy regulations would not preempt the state law.

### 4. Confidential Communications

Under the privacy rule, patients can request that their doctors, health plans and other covered entities take reasonable steps to ensure that their communications with the patient are confidential. For example, a patient could ask a doctor to call his or her office rather than home, and the doctor's office should comply with that request if it can be reasonably accommodated.

### 5. Health Plans and Providers

The privacy rule requires health plans, pharmacies, doctors and other covered entities to establish policies and procedures to protect the confidentiality of protected health information about their patients. These requirements are flexible and scalable to allow different covered entities to implement them as appropriate for their businesses or practices. Covered entities must provide all the protections for patients cited above, such as providing a notice of their privacy practices and limiting the use and disclosure of information as required under the rule. In addition, covered entities must take some additional steps to protect patient privacy.

### 6. Written Privacy Procedures

The rule requires covered entities to have written privacy procedures, including a description of staff that has access to protected information, how it will be used and when it may be disclosed. Covered entities generally must take steps to ensure that any business associates who have access to protected information agree to the same limitations on the use and disclosure of that information.

Covered entities must train their employees in their privacy procedures and must designate an individual to be responsible for ensuring the procedures are followed. If covered entities learn an employee failed to follow these procedures, they must take appropriate disciplinary action.

### 7. Public Responsibilities

In limited circumstances, the final rule permits—but does not require—covered entities to continue certain existing disclosures of health information for specific public responsibilities. These permitted disclosures include: emergency circumstances; identification of the body of a deceased person, or the cause of death; public health needs; research that involves limited data or has been independently approved by an Institutional Review Board or privacy board; oversight of the health care system; judicial and administrative proceedings; limited law enforcement activities; and activities related to national defense and security. The privacy rule generally establishes new safeguards and limits on these disclosures. Where no other law requires disclosures in these situations, covered entities may continue to use their professional judgment to decide whether to make such disclosures based on their own policies and ethical principles.

### 8. Equivalent Requirements for Government

The provisions of the final rule generally apply equally to private sector and public sector covered entities. For example, private hospitals and government-run hospitals covered by the rule have to comply with the full range of requirements.

Facsimile Machines

The systems and methods described below can be integrated into a fax machine so as to enable health care providers to comply with the above described regulations. A fax machine is a device that can send or receive pictures and text over a telephone line. Fax machines work by digitizing an image—dividing it into a grid of dots. Each dot is either on or off, depending on whether it is black or white. Electronically, each dot is represented by a bit that has a value of either 0 (off) or 1 (on). In this way, the fax machine translates a picture into a series of zeros and ones (called a bit map) that can be transmitted like normal computer data. On the receiving side, a fax machine reads the incoming data, translates the zeros and ones back into dots, and reprints the picture.

The idea of fax machines has been around since 1842 when Alexander Bain invented a machine capable of receiving signals from a telegraph wire and translating them into images on paper. In 1850, a London inventor named F. C. Blakewell received a patent for a similar machine, which he called a copying telegraph.

While the idea of fax machines has existed since the 1800s, fax machines did not become popular until the mid 1980s. The spark igniting the fax revolution was the adoption in 1983 of a standard protocol for sending faxes at rates of 9,600 bps. The standard was created by the CCITT standards organization and is known as the Group 3 standard. Now, faxes are commonplace in offices of all sizes. They provide an inexpensive, fast, and reliable method for transmitting almost anything including correspondence, contracts, resumes, handwritten notes, and illustrations.

A fax machine consists of an optical scanner for digitizing images on paper, a printer for printing incoming fax messages, and a telephone for making the connection. The optical scanner generally does not offer the same quality of resolution as stand-alone scanners. Some printers on fax machines are thermal, which means they require a special kind of paper.

Most fax machines conform to the CCITT Group 3 protocol, with some conforming to the CCITT Group 4 protocol, requiring ISDN lines. The Group 3 protocol supports two classes of resolution: 203 by 98 dpi and 203 by 196 dpi. The protocol also specifies a data-compression technique and a maximum transmission speed of 9,600 bps. The disclosed invention supports Group 3, Group 4, and the like.

Some of the features that differentiate one fax machine from another include the following:

speed: fax machines transmit data at different rates, from 4,800 bps to 28,800 bps. A 9,600-bps fax machine typically requires 10 to 20 seconds to transmit one page.

printer type: Some fax machines use a thermal printer that requires special paper that tends to turn yellow or brown after a period. More expensive fax machines have printers that can print on regular bond paper.

paper size: The thermal paper used in most fax machines comes in two basic sizes: 8.5-inches wide and 10.1-inches wide. Some machines accept only the narrow-sized paper.

paper cutter: Some fax machines include a paper cutter because the thermal paper that most fax machines use comes in rolls. The least expensive models and portable faxes, however, may not include a paper cutter.

paper feed: Some fax machines have paper feeds so that you can send multiple-page documents without manually feeding each page into the machine.

autodialing: Some fax machines come with a variety of dialing features. Some enable you to program the fax to send a document at a future time so that you can take advantage of the lowest telephone rates.

Methods

The methods typically pertain to the transmission of medical information as discussed herein. In other words, a medical message is produced and is intended to be transmitted. The methods disclosed herein aid in authenticating that the recipient of the medical information is the intended recipient.

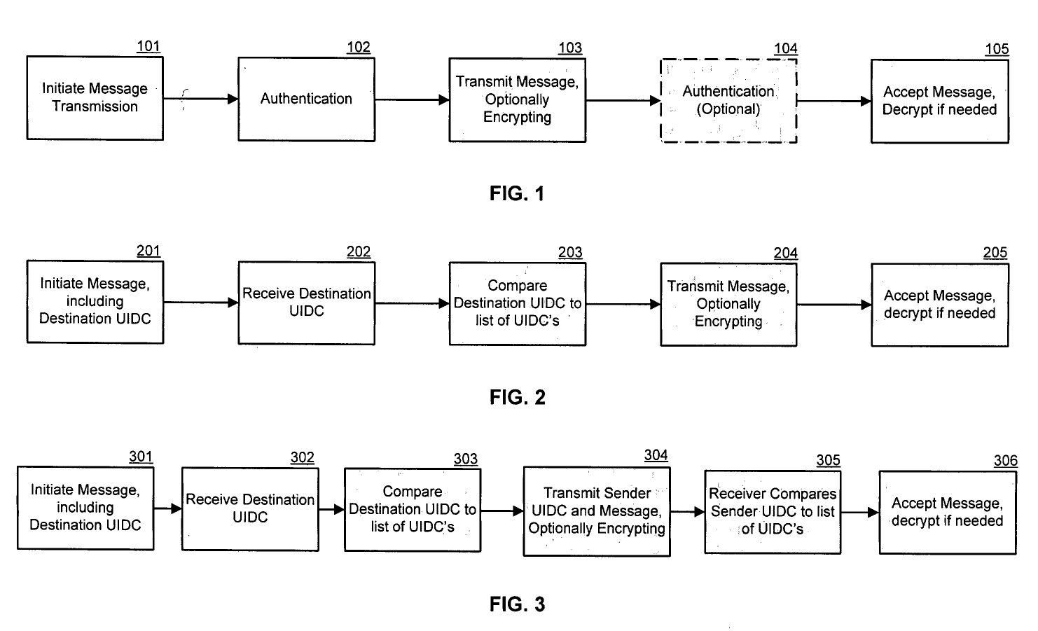

The methods generally pertain to transmitting any form of message. Initiation of message transmission [FIG. 1, 101] can include dialing a phone number, dialing a fax number, typing an email address, or depressing a button. After transmission of the message by the sender, generally an authentication step [FIG. 1, 102] of a recipient occurs. It is understood that the authentication step can occur of both the receiver by the sender and the sender by the receiver [FIG. 1, 106]. The message transmission [FIG. 1, 103] can be electronic, and will typically occur after the authentication step has indicated that the receiver is the intended receiver. A message can be a fax message, a telephone transmission, an email, or the like. The message can be encrypted by the sending apparatus and decrypted by the receiving apparatus. The encryption methods can include carrying DES or RSA keys. The message can be received [FIG. 1, 105] by a fax machine, a telephone, a modem, or the like. It is understood as discussed herein that both senders and receivers can employ existing equipment, such as existing fax machines, by interspersing an apparatus as discussed herein which can perform the authentication step as discussed herein. However, the authentication step can also be integrated into machines, such as fax machines, and can be loaded onto computers, capable of sending and receiving faxes, by loading the appropriate software as disclosed herein, on the machine.

### 9. Alternative Authentication Methods

All authentication embodiments can be performed with more than one sender UIDC, more than one recipient UIDC, or both.

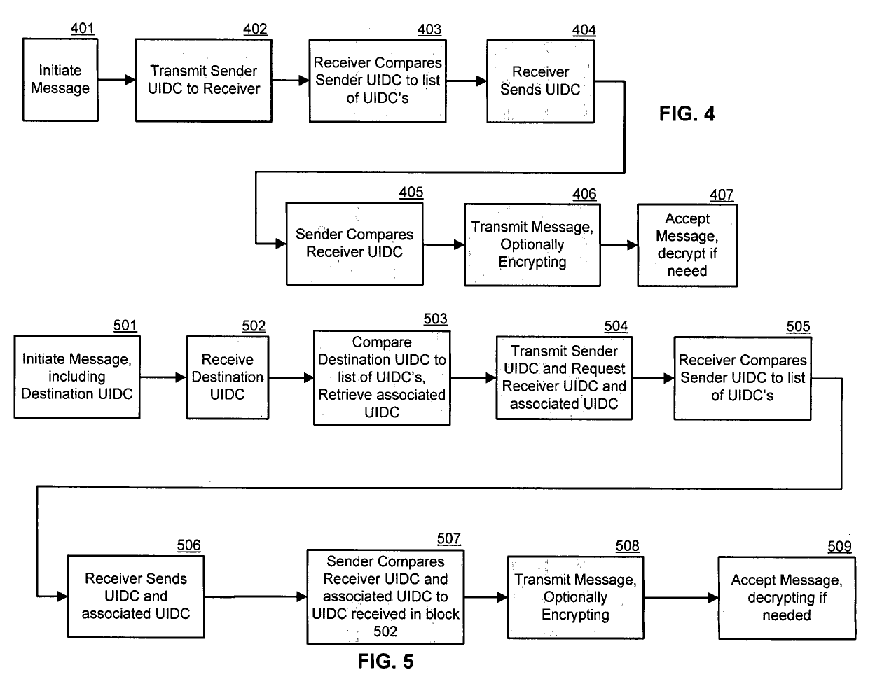

For example, FIG. 2 shows the authentication method can comprise initiation of a message transmission, including a destination UIDC [201] and the sending apparatus receiving a destination UIDC [202] and comparing said UIDC representing a destination to an ACL [203]. Upon locating the UIDC in the ACL, the message can be transmitted [204] and accepted by the receiver, decrypting if necessary [205]. FIG. 3 shows another example. The authentication method can comprise initiation of a message transmission, including a destination UIDC [301]. The sending apparatus can receive a destination UIDC [302] and compare said UIDC representing a destination to an ACL [303]. Upon locating the UIDC in the ACL, the sender UIDC and message can be transmitted [304]. The recipient apparatus, upon receipt of sender UIDC and message, can compare the sender UIDC to an ACL [305]. If the UIDC is located, the fax is received, and decrypted if necessary [306]. If the UIDC is not found, the fax is blocked. Another example is shown in FIG. 4. The authentication method can comprise initiation of a message transmission [401] and sending a UIDC to a destination apparatus [402]. Upon receipt, the destination apparatus can locate the sender apparatus UIDC in an ACL [403] and respond with a UIDC [404]. The sender, upon receipt of the destination UIDC response and locating the response UIDC in an ACL [406], can transmit the message [406]. The fax is received, and decrypted if necessary [407].

Another example is shown in FIG. 5. The authentication method can comprise comprise initiation of a message transmission, including a destination UIDC [301]. The sending apparatus can receive a destination UIDC [502] and compare said UIDC representing a destination to an ACL [503]. Upon locating the UIDC in an ACL, a second associated UIDC is returned [503]. The sender apparatus transmits its UIDC and a request for the destination UIDC and destination associated UIDC [504]. The recipient apparatus compares the sender UIDC to an ACL, upon location of the sender UIDC in the ACL [505], the recipient transmits its UIDC and associated UIDC [506]. The sender, upon receipt and confirmation of the two UIDCs [507], transmits the message [508]. The fax is received, and decrypted if necessary [509].

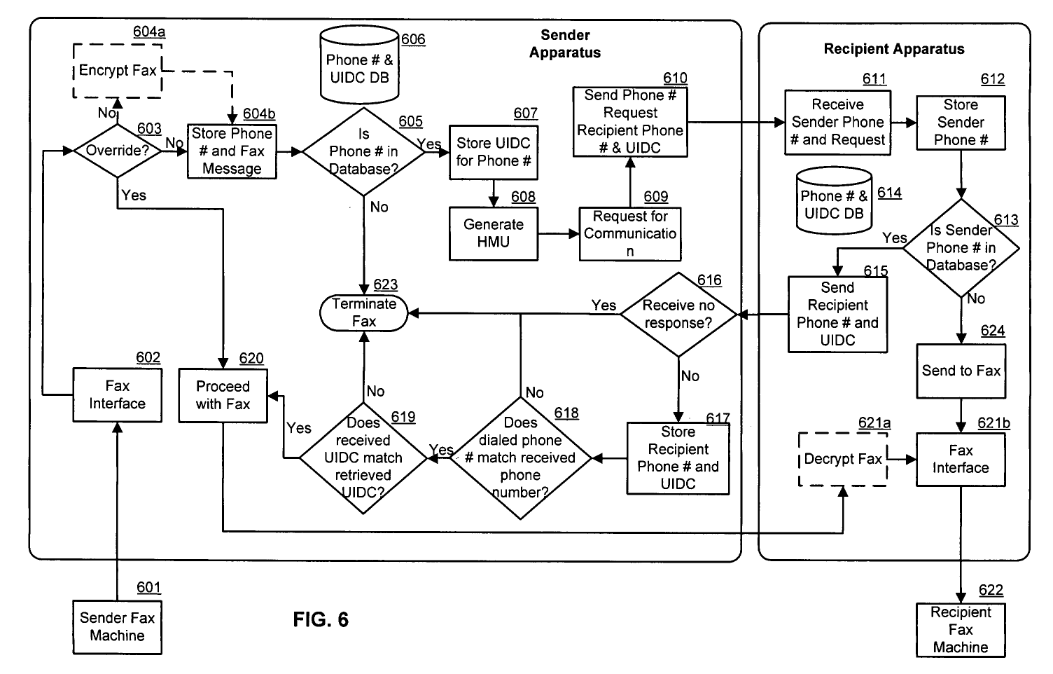

Another example is shown in FIG. 6. Normal fax machine operation is as usual—documents are fed into the fax machine and a number is dialed. The fax machine dials out as usual but the dial tones are intercepted by the apparatus [602] and processed as follows:

The apparatus will check if the number dialed is preceded by an override code [603], if so, then override mode is enabled for this one transmission and a normal fax transmission ensues [620]. The apparatus simply passes the number tones from the fax machine [601] to the telephone line for transmission to the recipient fax machine [622] without further processing, and the fax machine [601] itself handles the connection and transmission.

Otherwise, the number can be recorded by the apparatus as it is passed to the telephone line [604b]. The apparatus can encrypt the fax message [604a] and the apparatus can also store the fax message [604b]. The apparatus can compare the stored phone number [605] to the phone numbers and UIDC's contained in the ACL [606]. If no matching phone number is found, the fax communication is terminated [623]. However, if a matching phone number is found, the apparatus can store the UIDC associated with that phone number [607]. The apparatus can generate a Handshake Message Unit (HMU) [608] and can contact the recipient with a request for communication [609].

If the request for communication is not recognized [616], (i.e. there is no corresponding apparatus on the receiving end), the transmission is blocked [623], and an error report can be generated.

If the request for communication is recognized, the apparatus sends its own phone number and requests the phone number and associated UIDC of the receiving apparatus [610]. The apparatus can receive the recipient confirmation phone number and associated UIDC [616]. The apparatus can store the confirmation phone number and associated UIDC received [617]. The apparatus can compare the received confirmation phone number to the dialed phone number [618]. If the confirmation phone number received [616] from the recipient does not match the dialed phone number, transmission is blocked [623] and an error report can be generated.

If the received confirmation phone number does match the dialed phone number, the apparatus can compare the UIDC associated with the dialed phone number to the received UIDC associated with the confirmation phone number [619]. If the UIDC's do not match, the fax is terminated [623] and an error report can be generated. If the UIDC's do match, transmission of the fax is allowed to proceed [620].

Upon receipt of a call, the apparatus can intercept the call. If there is no request for communication being received (i.e. there is no active apparatus on the transmitting end) the call can be passed through passively to a fax machine connected to the apparatus.

If there is a request for communication, the apparatus acknowledges and receives the sending apparatus phone number [611]. The apparatus can store the sending apparatus phone number [612]. The apparatus can compare [613] the stored sending phone number [612] to the phone numbers and associated UIDC's in the ACL [614]. If the stored sending phone number is not located in the ACL, the fax is allowed to pass [624] to the fax machine [622] through the fax interface [621b].

If the stored sending apparatus phone number is located in the ACL, the apparatus can respond to the sending apparatus request for phone number and UIDC [611] by transmitting its confirmation phone number and associated UIDC [615]. The originating sending apparatus can receive [616] and store [617] the recipient's confirmation phone number and associated UIDC. The originating sending apparatus can compare the recipient's confirmation phone number [618] and associated UIDC [619] to the stored phone number and UIDC. If the phone numbers and associated UIDCs do not match, the transmission is terminated [623]. If the phone numbers and associated UIDCs match, the transmission initiates and [encrypted] fax transmission ensues[620], the incoming data stream can be received into recipient apparatus memory buffer, can be decrypted [621a], and can be passed on to a receiving fax machine [622] by sending a standard fax sequence to a fax machine [622] via a fax interface [621b].

### B. APPARATUSES AND SYSTEMS

It is understood that the disclosed methods are performed on a device, capable of performing the steps electronically, such as a computer. It is also understood that the disclosed methods can be performed on a stand alone apparatus, which can be used in conjunction with existing machinery, such as fax machines or computer fax machines. The methods can also be performed on existing machines such as fax machines or computers by updating the software of these machines to include software capable of implementing the disclosed methods. Furthermore, the disclosed methods can be performed on machines, such as fax machines or computers which have the device or software integrated. The apparatus can comprise hardware and/or software that can verify a recipient (via its unique identifier code, or UIDC), that can confirm its own identity (by transmitting its own unique UIDC), and that can encrypt/decrypt faxes. Each apparatus can have a hardware-encoded and unchangeable UIDC. The apparatus can interpose between a message communications device, such as a fax machine, and a communications medium, such as a telephone line. In the case of a standard fax machine, the telephone cable from the wall plugs into the apparatus via a standard telephone cord, while a second standard phone cord and jack can connect from the apparatus to the fax machine. The apparatus typically requires its own power supply and the power cord plugs can plug into a standard wall outlet, alternatively the apparatus can be battery operated, or powered through a USB port, for example. In this respect the setup is identical to that of a telephone answering machine. When the apparatus is powered off, all telephone calls pass through passively to the fax machine. The apparatus hardware can be controlled by firmware written in a computer language such as JAVA.

### a) Apparatus Functions

The following functions can be incorporated into the apparatus: Create/Read/Update/Delete (CRUD) of ‘phone number-UIDC’ lists (ACL), Synchronize above data with Admin Console, Receive Firmware updates from Admin Console, Intercept Phone calls from Fax machine, Allow straight-through phone calls to the receiver, and sender (based on the apparatus location such as at Sender side or Receiver side), Read/Create Handshake Message Unit (HMU), Establish conversation with the partner apparatus, Establish Handshake (send and receive HMU), Authenticate partner UIDC, Terminate conversation with partner, and Error reporting to Fax Machine alone or collectively in any combination.

### b) Apparatus Setup

Communication to the apparatus for programming of features or editing the caller list can be accomplished through the softkeys, via USB or Firewire connector directly to a computer, by calling into the apparatus via a standard telephone call (from another telephone) line using a computer with a modem, or wirelessly. After completing the hardware setup, the following typically is performed to prepare the device for operation. For example, the UIDC of each of the approved recipients, along with their telephone number is provided. This forms the approved caller list (ACL). Telephone numbers and UIDC's can be entered in a number of ways. For example, they can be entered manually, at the time of telephone number entry or later. Another example, is where they are entered by calling out to the recipient fax machine and querying it for its UIDC. That UIDC is then associated automatically with that telephone number. The numbers can also be entered from existing databases or through other electronic transfer. Also, there can be a function of specifying whether an override mode is to be allowed. For example, for the override feature to be invoked, a user must specify a numeric or alphanumeric password to access supervisor level functions; but default can be no password or a preset password.

### c) Apparatus Updating

If the apparatus receives a “maintenance” request for communication, it can accept firmware/software upgrades. This request for communication can include a separate nonprogrammable password that is hardware encoded and known only to the company; it can be used for troubleshooting and upgrades.

If the apparatus receives an “edit” request for communication, it can enter edit mode. This request for communication can include a separate, user programmable password (default 0000), this password can also be provided to the software on the computer trying to dial in to the apparatus. Once accepted, the apparatus can allow editing of the ACL via the remote calling computer.

### d) Stand Alone Apparatus

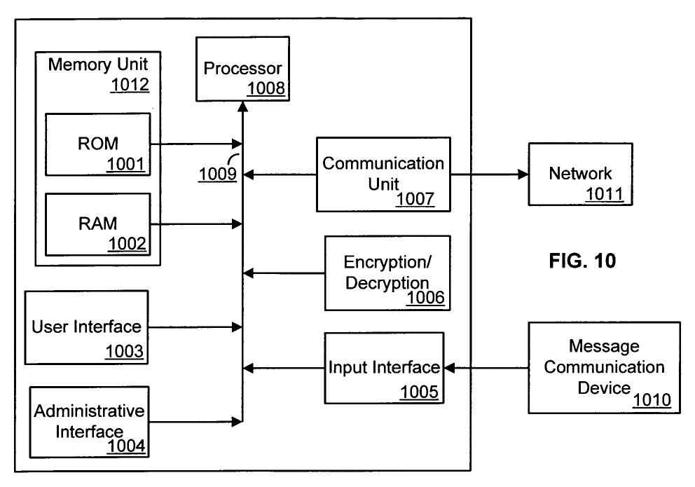

FIG. 10 is a block diagram showing in more detail an exemplary apparatus. In FIG. 10, the apparatus can include a memory unit 1012, a user interface 1003, an administrative interface 1004, an input interface 1005, an encryption/decryption unit 1006, a communication unit 1007, a processor 1008, an internal bus 1009, and a memory unit 1012.

The processor 1008 controls the apparatus according to programs and data stored in ROM 1001. The processor 1008 can be any special purpose or general purpose processor.

The memory unit 1012 can comprise ROM 1001 and RAM 1002. The ROM 1001 stores control programs to be performed by the processor 1008. The ROM 1001 stores various kinds of parameters and information specific to the apparatus, and has a working memory area used by the processor 1008. The UIDC-Telephone number lists can be maintained as simple array lists in the ROM 1001. This list can be populated directly through the user interface 1003 or can be captured on an Admin Console (not shown) and synchronized with the apparatus periodically via the administrative interface 1004. These lists can be stored in a light-weight database such as MS Access or written into physical file structures. The RAM 1002 stores compressed image data to be transmitted and data received from a remote message communication device (not shown).

The communication unit 1007 controls data communication procedure via communication protocols, including group 3 standard procedure and non-standard procedure. The communication unit 1007 controls the connection with a network 1011 to transmit and receive image (message) data to a remote message communication device (not shown). The communication unit 1007 can include a modem (not shown) for performing functions of the group 3 facsimile and includes a low-speed modem function, such as a V.21 modem, for transmitting and receiving communication protocols and a high-speed modem function, for example, V.17, V.34, V.29, V.27 modems, for transmitting and receiving image data. The communication unit 1007 can include other communication hardware known in the art including a network adapter (not shown) which can be implemented in both wired and wireless environments. Interaction between apparatuses can be based on a handshake message unit (HMU).

The communication unit 1007 can generate an HMU. The HMU can comprise a message header, a message body and a message trailer. Information such as the request type, conversation state etc., can be encoded into the message header, while the data to be transmitted between the apparatuses can be placed in the message body. The message trailer can be used for other purposes such as carrying DES or RSA keys for encryption purposes.

The encryption/decryption unit 1006 can encrypt, if transmitting, or decrypt, if receiving, image data. DES or RSA keys can be appended to a message trailer, for example, for encryption purposes.

The user interface 1003 can include a display panel and operational keys for inputting commands and parameters. The apparatus can have an LCD screen or similar display, and can have a control panel. The control panel buttons can comprise: power, softkeys, whose functions vary depending upon the active screen currently on the LCD and help.

The input interface 1005 can have a data port for receiving image (message) data from a message communication device 1010. The apparatus can contain two or more other communication ports for communicating with a message transmission device. A message transmission device can comprise a fax machine, a telephone, or a modem. The ports can be labeled “Telco” and “Fax”, each of which can accept a standard telephone jack connection. The ports can alternatively accept RJ45 cable and similar communication transmission cable. Additionally, the input interface 1005 can be wireless, such as an 802.11 standard, infrared, and the like. It can have a power source connection or it can be battery powered. Alternatively, the apparatus can be built directly into a message communications device 1010 such as a fax machine, computer, or a telephone.

The administrative interface 1004 can have a communications port for communicating with an Admin Console. An Admin Console can be a personal computer or similar control device. Such a communications port can be a USB (Universal Serial Bus) port or a Firewire (IEEE 1394) port. The interaction between the apparatus and the Admin Console can static, and the apparatus and the message communications device 1010 can interact at runtime (dial-time) before establishing a connection with another apparatus or message communications device 1010. The Admin Console can be built into the apparatus, can be built into a message communications device 1010 (such as a fax machine), or can be external to the apparatus (such as a personal computer). The following functions can be supported by the Admin Console: Application development environment, this can include JAVA, C++, C#, and similar programming languages; Firmware updates to the apparatus; Supervisory functions on the apparatus such as CRUD on Phone Number-UIDC (ACL) data; Data synchronization with apparatus; Ability to bum the software (firmware) onto EPROMs; Java Telephony API alone or in combination. If the apparatus firmware application is developed in Java, the Java Telephone API can serve as the infrastructure to provide apparatus-apparatus interactions during the request for communication.

An internal bus 1009 is connected to the user interface 1003, the administrative interface 1004, the input interface 1005, the encryption/decryption unit 1006, the communication unit 1007, the processor 1008, and the memory unit 1012 and allows communication between the aforementioned components therethrough.

### C. EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Example 1

### Sender Apparatus→Receiver Apparatus

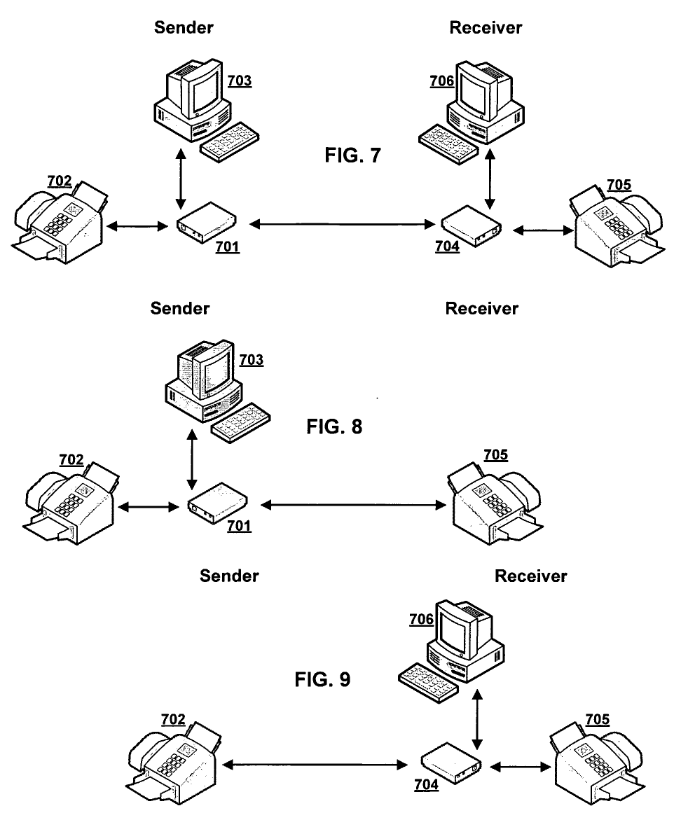

In this scenario, both sides of the communication have apparatuses attached to their Fax Machines and both apparatuses participate in the conversation. This scenario is typical of the Provide-to-Provider data exchange. The following diagram illustrates a sequence of events of this topology. FIG. 7 illustrates a sending apparatus [701] connected to a sending fax machine [702]. An administrative console [703], displayed here as a personal computer, is connected to the sending apparatus [701]. The sending apparatus [702] transmits to a receiving apparatus [704] that is connected to a receiving fax machine [705]. An administrative console [706], displayed here as a personal computer, is connected to the receiving apparatus [704].

| Fax Machine | Apparatus(S) | Apparatus(R) | Fax Machine |
|---|---|---|---|
| Originate Call | Intercept Call | | |
| | Check for override | | |
| | If override is YES, pass/ | | |
| | If not, check if the receiver is in ACL | | |
| | If not in ACL, terminate fax | | |
| | If in ACL, Generate Message Unit | | |
| | Fill in header, body and trailer | | |
| | Establish conversation with receiver apparatus | | |
| | | Handshake with apparatus (S) | |
| | | Check if the sender is in ACL | |
| | | If found in ACL | |
| | | Respond with UIDC and | |
| | | Phone no. | |
| | | If not in ACL | |
| | | Pass call to Fax Machine | |
| | | | Receive Fax |
| | Receive Receiver data | | |
| | Authenticate Receiver | | |
| | If successful, proceed with fax | | |
| | Else, notify error to Fax machine, end call | | |
| If authenticated, | | | |
| Send fax | | | |
| | | | Receive |
| | | | Fax |

### 2. Example 2

### Sender Apparatus→Receiver Fax Machine

This topology will be implemented typically in a Provider-Patient scenario. In this case, the receiver is either an end customer of that provider, such as a patient, or another provider without an apparatus. This second model almost immediately should result in a transmission failure because every Recipient provider should pass through apparatus authentication process. Where as the first model is acceptable and the following sequence of events represent the first model of data communication/transmission. FIG. 8 illustrates a sending apparatus [701] connected to a sending fax machine [702]. An administrative console [703], displayed here as a personal computer, is connected to the sending apparatus [701]. The sending apparatus [702] transmits to a receiving fax machine [705].

| Fax Machine | Apparatus(S) | Fax Machine |
|---|---|---|
| Originate Call | Intercept Call | |
| | Check for override | |
| | If override is YES, pass/ | |
| | If not, check if the receiver is in ACL | |
| | If in ACL, Generate Message Unit | |
| | Fill in header, body and trailer | |
| | Establish conversation with receiver | |
| | apparatus | |
| | Send the Handshake Sequence | |
| | | No Response |
| | Receive No Response | |
| | Terminate Fax | |

### 3. Example 3

### Sender Fax Machine→Receiver Apparatus

This topology will be typical of Patient-Provider scenario. In this case, the sender is the end customer of that provider, such as a patient. FIG. 9 illustrates a sending fax machine [702] transmitting to a receiving apparatus [704] that is connected to a receiving fax machine [705]. An administrative console [706], displayed here as a personal computer, is connected to the receiving apparatus [704].

| Fax Machine | Apparatus(R) | Fax Machine |
|---|---|---|
| Originate Call | Intercept Call | |
| | Check if the sender is in ACL | |
| | If YES, look for apparatus Handshake | |
| | sequence | |
| | If handshake found, respond with | |
| | Handshake | |
| | Else, reject call | |
| | If not in ACL, | |
| | Pass the call to the Fax Machine | |
| | | Receive Fax |

What is claimed is:

1. A method of authenticated information transmission comprising:
initiation of information transmission; authentication; and transmission of information.

2. The method of claim 1, wherein the information is a facsimile message.

3. The method of claim 1, wherein the authentication step comprises:
authentication of recipient.

4. The method of claim 1, wherein the authentication step comprises:
authentication of recipient; and authentication of sender.

5. The method of claim 1, wherein the authentication step comprises:
authentication of sender.

6. The method of claim 3, wherein the authentication step comprises:
comparing a recipient unique identifier code to a list of approved recipient unique identifier codes.

7. The method of claim 4, wherein the authentication step comprises:
comparing a recipient unique identifier code to a list of approved recipient unique identifier codes; comparing a sender unique identifier code to a list of approved sender unique identifier codes.

8. The method of claim 5, wherein the authentication step comprises:
comparing a sender unique identifier code to a list of approved sender unique identifier codes.

9. The method of claim 1, wherein the authenticated information comprises medical information.

10. A method of transmitting medical information in an authenticated manner via facsimile, the method comprising:
generating a message in electronic format;
selecting a recipient phone number associated with a recipient facsimile device;
comparing the recipient phone number to a stored list of approved phone numbers, wherein the stored list includes an associated unique identifier code for each approved recipient phone number;
retrieving the unique identifier code associated with the recipient phone number from the stored list;
connecting to the recipient facsimile device by dialing the recipient phone number, only if the phone number is found in the stored list;
receiving a confirmation phone number and a confirmation identifier code from the recipient facsimile device;
comparing the received confirmation phone number to the recipient phone number;
comparing the received identifier code to the retrieved unique identifier code; and
transmitting the message to the recipient facsimile device, only if the received confirmation phone number matches the recipient phone number and the received identifier code matches the retrieved unique identifier code.

11. The method of claim 10 wherein the method further comprises:
encrypting the generated message.

12. A method of receiving medical information in an authenticated manner from a transmitting facsimile device to a receiving facsimile device, the method comprising:
receiving a request for communication from the transmitting facsimile device;
receiving a confirmation phone number from the transmitting facsimile device;
comparing the confirmation phone number to a stored list of approved phone numbers,
wherein the facsimile transmission is terminated if the confirmation number is not contained in the stored list of approved phone numbers;
transmitting a recipient phone number associated with the receiving facsimile device and an associated unique identifier code to the transmitting facsimile device; and
receiving facsimile transmission from the transmitting facsimile device.

13. The method of claim 12 wherein the method further comprises:
decrypting the received facsimile transmission.

14. A facsimile message authentication system for transmitting a message to a recipient facsimile device, the recipient facsimile device having an associated unique identifier code, the system comprising:
means for generating a message in electronic format;
means for selecting a recipient phone number associated with a recipient facsimile device;
means for comparing the recipient phone number to a stored list of approved phone numbers, wherein the stored list includes an associated unique identifier code for each approved recipient phone number;
means for retrieving the unique identifier code associated with the recipient phone number from the stored list;
means for connecting to the recipient facsimile device by dialing the recipient phone number, only if the phone number is found in the stored list;
means for receiving a confirmation phone number and a confirmation identifier code from the recipient facsimile device;
means for comparing the received confirmation phone number to the recipient phone number;
means for comparing the received identifier code to the retrieved unique identifier code; and
means for transmitting the message to the recipient facsimile device, only if the received confirmation phone number matches the recipient phone number and the received identifier code matches the retrieved unique identifier code.

15. The system of claim 14 further comprising:
means for encrypting generated electronic message.

16. A facsimile message authentication system for receiving a message from a transmitting facsimile device, the transmitting facsimile device having an associated unique identifier code, the system comprising:
means for receiving a request for communication from the transmitting facsimile device;
means for receiving a confirmation phone number from the transmitting facsimile device;
means for comparing the confirmation phone number to a stored list of approved phone numbers, wherein the facsimile transmission is terminated if the confirmation number is not contained in the stored list of approved phone numbers;
means for transmitting a recipient phone number associated with the receiving facsimile device and an associated unique identifier code to the transmitting facsimile device; and
means for receiving facsimile transmission from the transmitting facsimile device.

17. The system of claim 16 further comprising:
means for decrypting facsimile transmission.

18. A device for authenticated message transmission, comprising:
an input interface adapted for receiving a message and a communication address;
a memory unit for storing the message and the communication address, and for storing a listing of approved communication addresses;
a processor coupled to the memory unit, wherein the processor determines whether the communication address is present in the listing of approved communication addresses stored in the memory unit; and
a communication unit coupled to the processor wherein the communication unit transmits a handshake message unit to a remote message receiving device associated with the communication address, if the communication address is present in the listing of approved communication addresses.

19. The device of claim 18 further comprising:
an encryption/decryption unit coupled to the communication unit adapted to encrypt an outgoing handshake message unit and adapted to decrypt an incoming handshake message unit.

20. The device of claim 18 further comprising:
a user interface coupled to the memory unit adapted to update the listing of approved communication addresses.

21. The device of claim 18 further comprising:
an administrative interface coupled to the memory unit adapted to update functionality of the device.
